(19) United States
(12) Patent Application Publication
(10) Pub. No.: US 2009/0095495 A1
(43) Pub. Date: Apr. 16, 2009

(54) ROTATING AGRICULTURAL TOOL WITH BEARING ARRANGEMENT

(75) Inventors: Markus Spohn, Oberreichenbach (DE); Erich Lunz, Lonnerstad (DE); Jens Krueger, Nuernberg (DE); Christian Hoffinger, Georgensgmuend (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/279,588

(22) PCT Filed: Feb. 7, 2007
(86) PCT No.: PCT/EP07/51151

§ 371 Date: Sep. 24, 2008

(30) Foreign Application Priority Data
Feb. 18, 2006 (DE) 10 2006 007 580.3

(51) Int. Cl. A01B 71/04; A01B 23/06; A01B 21/08

(52) U.S. Cl. 172/601; 384/157

(57) ABSTRACT

The invention relates to a rotating, disc-shaped, agricultural tool which is mounted in a frame of a machine via a hub and a bearing arrangement. The bearing arrangement is distinguished by the fact that it is formed from two angular roller bearings which are set in back-to-back arrangement and whose raceways are arranged inclined at an angle to a bearing axis, wherein a space accommodation the angular roller bearings is defined on the outside in the radial direction by a hub body, of V-shaped design in its centre part and having contact surfaces, and on the inside in the radial direction by a supporting ring having spaced-apart contact surfaces on both sides in the axial direction, wherein the hub body is provided at an axial end with a fastening element for fastening the tool. In this way, a captive bearing unit is provided which is already provided with the appropriate prestress and which only needs to be connected to the agricultural tool and to the frame by the end user, i.e. by the manufacturer of an agricultural machine.

### FIELD OF APPLICATION OF THE INVENTION

The invention relates to a rotating, disc-shaped, agricultural tool which is held in a frame of a machine via a hub and a bearing arrangement, the bearing arrangement having at least one inner ring and at least one outer ring and also a number of rolling bodies arranged between the inner ring and outer ring.

### BACKGROUND OF THE INVENTION

Examples of agricultural tools of this type include plough cutter discs in ploughs, cutting discs for sowing machines and discs for harrows. In arrangements of this type, the rotating disc is guided in a bearing arrangement which is frequently received by a short journal, the journal being fastened to a machine frame. The bearing arrangement is fastened in the frame at a specific distance above the ground, so that the blade of the disc can cut a furrow into the ground when the agricultural machine is drawn over the ground or moved therealong. During this process, the disc is exposed to variable loads, so that the disc must be arranged in suitable bearings which satisfy all demands. The bearing arrangement is very important in applications of this type when the agricultural tool cuts into the ground during use and in the process casts earth, pieces of rock and mud against the bearing arrangement, so that said bearing arrangement must be very well sealed from the environment.

An agricultural tool generically designed in this way is previously known from DE 828 168. As may be inferred from the single figure and the associated description, an axle bolt is received by a carrier element of the agricultural machine. The axle bolt carries in turn a rolling bearing which is configured as a ball bearing and the bearing outer ring of which is surrounded by a hub body which is in turn connected to the agricultural tool. A drawback of this is that a hub body of this type is, as a solid part, very complex to produce. The ball bearing, which is designed in a single row, is also limited in the accommodation of axial forces and moments.

Further generic bearing arrangements for agricultural tools are previously known from U.S. Pat. No. 2,768,864 and from DE 79 00 576 U1. Both cases display a bearing arrangement in which there is fastened in a frame of an agricultural machine an axle stub which carries in turn two ball bearings which are set apart from each other in the axial direction and in both cases are surrounded by a hub body which is designed as a separate component and is in turn connected to the agricultural tool. The drawbacks cited hereinbefore apply in this case too.

A further generic bearing arrangement for a rotating agricultural tool is known also from DE 200 12 666 U1. Use is made of a wheel bearing which is known from the automotive industry and is connected to a frame of the agricultural machine via an axle stub. The inner or outer ring of said wheel bearing is provided with a radially outwardly directed flange which has fastening holes which are set uniformly apart from one another over the circumference and serve to receive screws which detachably connect the agricultural tool to one of the bearing rings. A drawback of this is that a bearing arrangement of this type, which is designed as a two-rowed angular ball bearing, is very bulky and is also limited in the accommodation of axial forces.

Further bearings for agricultural tools which are at least indirectly related to the solution according to the invention are described in the prior publications listed hereinafter:

DE 933 360, DE 29 13 064 A1, DE 41 38 847 A1, DE 39 16 269 A1, DE 44 20 486 A1, U.S. Pat. No. 1,506,782, U.S. Pat. No. 2,566,991, U.S. Pat. No. 3,101,793, U.S. Pat. No. 4,136,746, U.S. Pat. No. 4,196,779, U.S. Pat. No. 4,590,869.

### SUMMARY OF THE INVENTION

Starting from the drawbacks of the known prior art, the invention is therefore based on the problem of providing a bearing arrangement for a high-capacity rotating agricultural tool, which arrangement is simple to manufacture, allows simplified mounting and can be delivered with set prestress. The bearing should also be well protected from external influences.

The solution to this problem is determined by the characterizing features of the main claim, the sub-claims containing advantageous developments.

The bearing arrangement according to the invention is distinguished in that the use of the angular roller bearings provides linear contact between the rolling bodies and surrounding components, thus affording a high load-bearing capacity. This has a particularly advantageous effect in the event of the occurrence of impact loads. A further advantage is that the angular roller bearings allow both radial forces and axial forces to be reliably accommodated. Another advantage is that the use of the hardened running discs, which are manufactured without cutting, allows the surrounding design to remain relatively soft, i.e. it does not need to be hardened. A further advantage is based in the fact that the displaceable adjusting ring allows the desired bearing prestress to be set in a simple manner. A further advantage is the reliable sealing of the bearing arrangement. The cassette seals, which are preferably arranged between the hub body and supporting ring, ensure a high sealing effect. In addition, this high sealing effect is further improved by preceding gap seals which are produced by covering discs arranged on the supporting ring on both sides. It is also advantageous that the one-piece design of the hub body and radially oriented flange produces a simple connection to the agricultural tool. Finally, a further advantage is that the bearing arrangement according to the invention is designed as a component which cannot become detached and already has the prestress defined by the subsequent operator, so that said operator needs merely to connect the bearing arrangement to the frame of his agricultural machine and to the agricultural tool in a simple manner by means of screwable fastening elements or otherwise.

The following exemplary embodiments of the invention will be described in greater detail.

### BRIEF DESCRIPTION OF THE DRAWINGS

FIGS. 1 to 5 are schematic longitudinal sections through different variant embodiments of a disc-shaped tool with the bearing arrangement according to the invention.

### DETAILED DESCRIPTION OF THE DRAWINGS

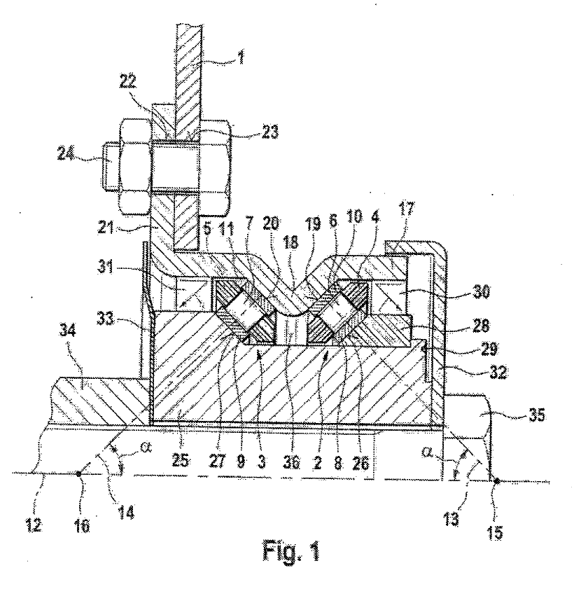

The rotating agricultural tool 1, in the form of a disc according to FIG. 1, has (in a manner not shown) on its outer circumference a blade with which it can penetrate the ground on rotation. As may be seen, the disc 1 is held via two angular roller bearings 2, 3 which are set apart from each other and of which the bearing needles 6, 7, which are guided in a cage 4, 5, roll off on running paths (not identified more precisely) which are formed by an inner running disc 8, 9 and by an outer running disc 10, 11. The space 36, which is substantially V-shaped in its configuration, for accommodating the angular roller bearings 2, 3 is defined, on the one hand, outwardly in the radial direction by a hub body 17 and, on the other hand, inwardly in the radial direction by a supporting ring 25. The running paths are arranged inclined at the angle α to the bearing axis 12, wherein the angle of inclination a can, depending on the application, move in a range between 45 and 65°. The angular roller bearings 2, 3 are set in back-to-back arrangement, i.e. the pressure lines 13, 14 of the rolling bodies 6, 7 run in the direction of the bearing axis 12 obliquely from the inside toward the outside and intersect said axis at the points 15, 16.

As mentioned hereinbefore, both angular roller bearings 2, 3 are outwardly received in the radial direction by a hub body 17 which forms the hub and has in its center part a V-shaped formation 18 which sets on both sides the inclined contact surfaces 19, 20 for the angular roller bearings 2, 3. At its left-side end, the hub body 17 merges with a fastening element in the form of a radially outwardly directed flange 21 which is provided with through-holes 22. The disc 1 also has through-holes 23, so that said disc can be connected in a simple manner to the hub body 17, via the flange 21 thereof, by means of fastening screws 24. However, other ways of fastening the disc 1 to the flange 21, such as welding or riveting, are also conceivable.

Inwardly in the radial direction, the angular roller bearings 2, 3 are received by a supporting ring 25 having on the left side the inclined contact surface 27, while the likewise inclined contact surface 26 arranged on the right side is formed by an adjusting ring 28 which is arranged on the supporting ring 25 such that it can be moved and secured axially. The desired bearing prestress is set in such a way that the adjusting ring 28 is brought into the correct axial position on the supporting ring 25 and fixed thereto. In the exemplary embodiment, the adjusting ring is secured with the aid of caulking 29. However, welding, crimping or riveting may also be considered for securing the adjusting ring 28 to the supporting ring 25.

As FIG. 1 also shows, the bearing arrangement is efficiently outwardly sealed; this is very important in agricultural tools on account of the conditions in which they are used. Sealing elements 30, 31, which reliably seal the space accommodating the angular roller bearings 2, 3, are arranged on both sides between the hub body 17, on the one hand, and the supporting ring 25 and adjusting ring 28, on the other hand. All types of seal are conceivable in the sense of the invention. What are known as cassette seals are particularly suitable owing to their very good sealing effect. It is not necessary to describe such seals in detail at this point, as they have been described in depth in a large number of prior publications. Cassette seals of this type have previously been described for example in DE 38 06 928 A1, DE 38 22 816 A1, DE 39 40 003 A1, DE 196 14 946 A1and in DE 200 05 585 U1.

In addition, two further gap seals precede the sealing elements 30, 31 on both sides. The gap seals are each formed by covering discs 32, 33 arranged on the right and left sides at the end face of the supporting ring 25. The gap seal is formed by the hub body 17 and the flange 21 thereof. In addition, to improve the sealing effect, the two gap seals have the additional effect that clumps of earth which cling to the hub body 17 and to the flange 21 thereof are sheared off by the stationary covering discs 32, 33 on rotation of the disc 1. In order in this case to prevent mechanical damage caused by the clumps of earth and stones, the covering discs 32, 33 must have sufficient mechanical strength.

As may also be seen from FIG. 1, the bearing module as a whole, consisting of the supporting ring 25, adjusting ring 28, angular roller bearings 2, 3, hub body 17, covering discs 32, 33 and sealing elements 30, 31, is fastened to the frame 34 of an agricultural machine in that a fastening screw 35 penetrates the bearing arrangement and is screwed into the frame 34.

The overall bearing arrangement is mounted in such a way that the angular roller bearing 3 arranged on the left side is first slid onto the supporting ring 25. Afterwards, also coming from the left side, the hub body 17 is slid on before the angular roller bearing 2 arranged on the right side is attached. Subsequently, the adjusting ring 28 is slid onto the supporting ring 25 and secured in the position corresponding to the desired bearing prestress. The mounting of the bearing arrangement is then continued with the insertion of the two sealing elements 30, 31 between the hub body 17 and the supporting ring 25 or the adjusting ring 28. Finally, the two covering discs 32, 33 are arranged on the right and left sides with the aid of the fastening screw 35, the bearings being held together with the aid of a securing element (not shown) on the fastening screw 35. This forms a non-detachable bearing module which can be delivered to the end customer without collapsing into its individual components. The end customer needs merely to fasten his agricultural tool 1 in a simple manner and to fix the arrangement as a whole in the frame 34 of his agricultural machine with the aid of the fastening screw 35. The nature of the fastening of the bearing module to the frame 34 of the agricultural machine is in this case of secondary importance. Thus, it is for example conceivable for the supporting ring 25 to be provided with a threaded bolt and to be screwed into the frame 34 via said threaded bolt. A non-detachable welded connection can also be advantageous under specific conditions.

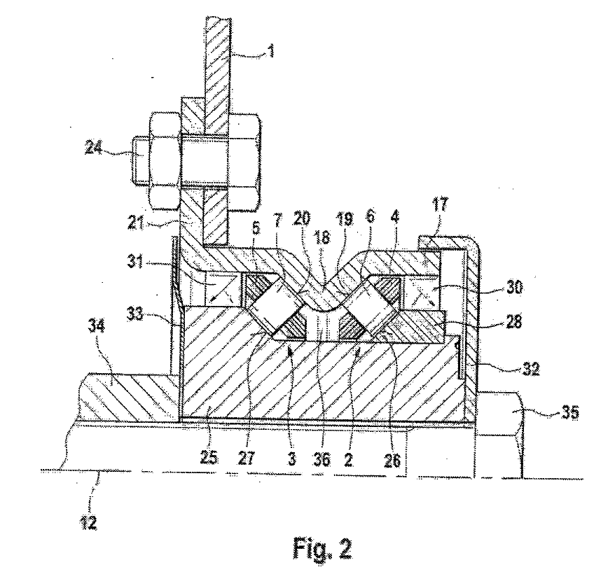

The bearing arrangement illustrated in FIG. 2 for the rotatable mounting of an agricultural tool differs from that in FIG. 1 merely in that no inner and outer running discs 8, 9, 10, 11 are present. The inner running paths for the rolling bodies 6, 7 guided in the cage 4, 5 are in this case formed by the contact surfaces 26, 27 of the adjusting ring 28 and supporting ring 25, whereas the outer running paths are set by the contact surfaces 19, 20 of the hub body 17. This assumes that they may be subjected to an appropriate heat treatment to increase their hardness.

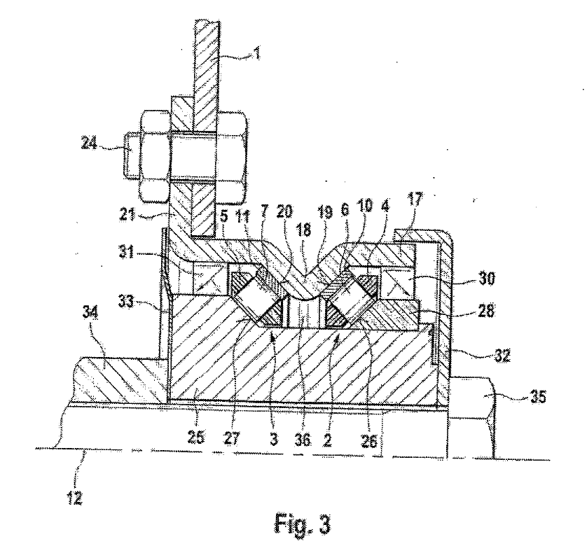

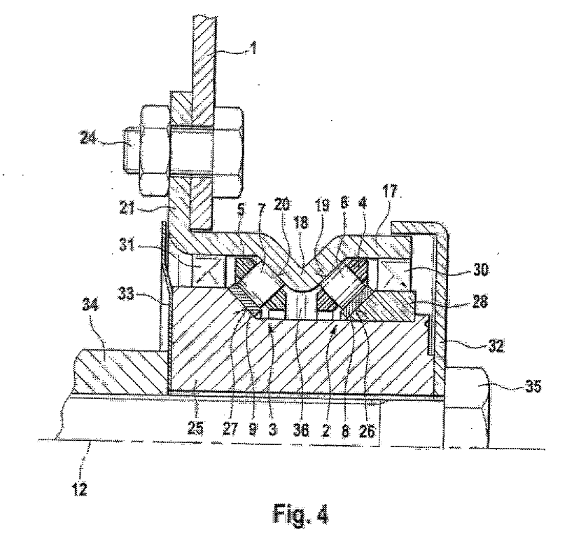

The bearing arrangements illustrated in FIGS. 3 and 4 differ in that in the first case only outer running discs 10, 11 and in the second case only inner running discs 8, 9 are present. Obviously, therefore, the inner running paths in the first case and the outer running paths in the second case are set for the rolling bodies 6, 7, which are guided in the cage 4, 5, by the contact surfaces 26, 27 of the adjusting ring and of the supporting ring 25 and by the contact surfaces 19, 20 of the hub body 17.

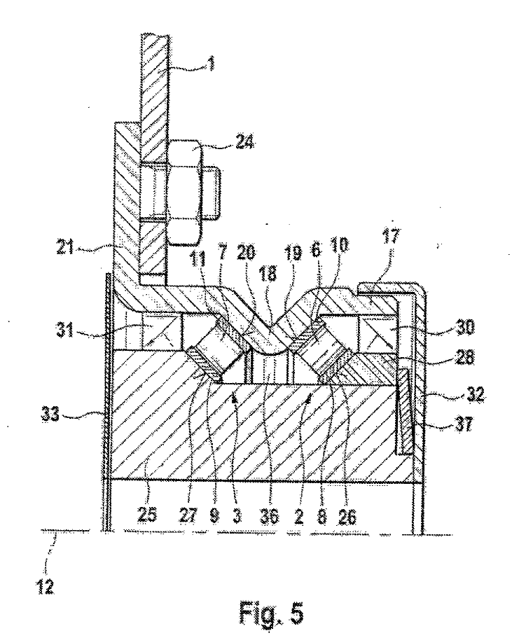

Finally, FIG. 5 shows a further bearing arrangement according to the invention which differs from that illustrated in FIG. 1 merely in terms of the fixing of the adjusting ring 28 to the supporting ring 25. As may be seen, a spring element 37 applies a force acting in the axial direction to the adjusting ring 28, the spring element resting on the covering disc 32.

### LIST OF REFERENCE NUMERALS

1 Agricultural tool
2 Angular roller bearing
3 Angular roller bearing
4 Cage
5 Cage
6 Bearing needle
7 Bearing needle
8 Inner running disc
9 Inner running disc
10 Outer running disc
11 Outer running disc
12 Bearing axis
13 Pressure line
14 Pressure line
15 Point
16 Point
17 Hub body
18 V-shaped formation
19 Contact surface
20 Contact surface
21 Flange
22 Through-hole
23 Through-hole
24 Fastening element
25 Supporting ring
26 Contact surface
27 Contact surface
28 Adjusting ring
29 Caulking
30 Sealing element
31 Sealing element
32 Covering disc
33 Covering disc
34 Frame
35 Fastening screw
36 Space
37 Spring element
α Angle of inclination

1. A rotating, disc-shaped, agricultural tool which is mounted in a frame of a machine via a hub and a bearing arrangement, comprising a bearing arrangement having at least one inner ring and at least one outer ring and also a number of rolling bodies arranged between the inner ring and outer ring, wherein the bearing arrangement is formed from two angular roller bearings which are set in back-to-back arrangement and the running paths of which are arranged inclined at an angle to a bearing axis, a space accommodating the angular roller bearings being defined outwardly in the radial direction by a hub body, of V-shaped design in its center part and having contact surfaces, and inwardly in the radial direction by a supporting ring having contact surfaces which are set apart from one another on both sides in the axial direction, the hub body being provided at an axial end with a fastening element for fastening the tool.

2. The agricultural tool as claimed in claim 1, wherein the running paths of the angular roller bearings are formed by an inner and/or an outer running disc.

3. The agricultural tool as claimed in claim 1, wherein the fastening element is a flange which extends radially outward and is provided with a plurality of receiving holes which are set apart from one another in the circumferential direction.

4. The agricultural tool as claimed in claim 1, wherein the hub body and the radially extending flange are formed in one piece and manufactured by a non-cutting shaping process.

5. The agricultural tool as claimed in claim 1, wherein the inner running discs of the angular roller bearings are received by the supporting ring.

6. The agricultural tool as claimed in claim 1, wherein the running discs are manufactured without cutting and subjected to a hardening process.

7. The agricultural tool as claimed in claim 1, wherein one of the contact surfaces is formed by an adjusting ring which is arranged on the supporting ring such that it can be moved and secured axially.

8. The agricultural tool as claimed in claim 1, wherein sealing elements are arranged on both sides between the hub body and the supporting ring.

9. The agricultural tool as claimed in claim 8, wherein the sealing elements are designed as cassette seals.

10. The agricultural tool as claimed in claim 1, wherein covering discs, which each form with the hub body a gap seal, are arranged one on each side of the supporting ring.

11. The agricultural tool as claimed in claim 1, wherein the rolling bodies are designed as bearing needles which are guided in a cage and roll off at an angle of inclination of from 45° to 65° relative to the bearing axis.

12. The agricultural tool as claimed in claim 1, wherein the bearing arrangement is detachably connected to the frame by a fastening screw penetrating said bearing arrangement.
